(19) United States
(12) Patent Application Publication
(10) Pub. No.: US 2025/0277952 A1
(43) Pub. Date: Sep. 4, 2025

(54) FIBER OPTIC TERMINALS, COMPENSATION RINGS, AND METHODS FOR ADJUSTING A SPLIT RATIO OF A FIBER OPTIC TERMINAL

(71) Applicant: CORNING RESEARCH & DEVELOPMENT CORPORATION, Corning, NY (US)

(72) Inventor: Blake Paul Lee, Corning, NY (US)

(21) Appl. No.: 19/056,156

(22) Filed: Feb. 18, 2025

Related U.S. Application Data
(60) Provisional application No. 63/559,543, filed on Feb. 29, 2024.

(51) Int. Cl. G02B 6/44

(52) U.S. Cl. CPC G02B 6/4472

(57) ABSTRACT

A fiber optic terminal having a variable ratio coupler that is adjusts power ratio splits using a rotating compensation ring along with related methods. In one embodiment, a compensation ring for a variable ratio fiber optic coupler includes a ring body and at least one arcuate slot within the ring body operable to receive at least one locking fastener. The compensation ring also includes a shaft opening within the ring body, where the at least one arcuate slot at least partially surrounds the shaft opening, the shaft opening defines an inner surface, and the inner surface includes a plurality of detent receiving features.

### RELATED APPLICATIONS

This application claims the benefit of priority of U.S. Provisional Application Ser. No. 63/559,543 filed Feb. 29, 2024, the content of which is relied upon and incorporated herein by reference in its entirety.

### FIELD

The disclosure is directed to fiber optic terminals having variable ratio couplers and tools for changing the output power level of optical outputs along with fiber optic networks using the terminals.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extends deeper into communication networks there exists a need for building more complex and flexible fiber optic networks in a quick and easy manner.

Terminals such as multiports or closures were also developed for making one or more optical connections with hardened connectors such as the OptiTap® plug connector. Prior art multiports have an input cable or input port with a plurality of receptacles mounted through a wall of the housing for protecting an indoor connector inside the housing that makes an optical connection to the external hardened connector of the branch or drop cable.

Illustratively, FIG. 1 shows a conventional fiber optic multiport 1 having an input fiber optic cable 4 carrying one or more optical fibers to indoor-type connectors inside a housing 3. The multiport 1 receives the optical fibers into housing 3 and distributes the optical fibers to receptacles 7 for connection with a hardened connector. The receptacles 7 are separate assemblies attached through a wall of housing 3 of the multiport 1. The receptacles 7 allow mating with hardened connectors attached to drop or branching cables (not shown) such as drop cables for “fiber-to-the-home” applications. During use, optical signals pass through the branch cables, to and from the fiber optic cable 4 by way of the optical connections at the receptacles 7 of multiport 1. Fiber optic cable 4 may also be terminated with a fiber optic connector 5.

Multiport 1 allows quick and easy deployment by service providers for passive optical networks. Further, multiport 1 may use a coupler or splitter inside the multiport to allow a single input optical signal to be split into multiple output channels. By way of explanation, the input fiber optic cable may have a single optical fiber that is in optical communication with a 1:N splitter for outputting N output signals. However, the power level of the input optical channel is divided among the N output signals in a passive optical network (e.g., no active components are used in the passive portion of the optical network). By way of explanation, a 1:2 coupler may split the power from the single input optical fiber as 50% power for the first output optical signal and 50% power for the second output optical signal. Other couplers may have unequal splits in the power level as desired such as splitting the power from the single input optical fiber as 80% power for the first output optical signal and 20% power for the second output optical signal depending on the requirements for the fiber optic network. Furthermore, multiports may be daisy-chained together for building more complicated fiber optic networks with further power level splits for the distribution of passive optical signals. By way of a simple explanation, an input optical signal from the central office may be able to accommodate a total split of 1:16 for the given input power level of the optical signal. An upstream multiport may have a 1:2 split with equal power levels for the two output fibers that each feed separate downstream multiports having a further 1:8 split with equal power levels, thus the single input fiber is split into 16 output signals each having an equal power level. Alternatively, a single multiport can incorporate a 1×2 splitter with unequal power split, with one output connected to a 1×N equal power splitter and the other connected to a downstream multiport.

However, conventional couplers or splitters have a fixed power level split for the output signals. This requires many individual couplers or splitters each having its own SKU, which increases both manufacturing and inventory costs. Moreover, fixed power level split does not readily allow for easy modification to the fiber optic network due to changed circumstances such as adding new customers or adapting the power levels needed for different loss budgets across the length of the passive optical network.

Consequently, there exists an unresolved need for terminals that provide quick and easily deployment for the fiber optic network in a flexible manner while also addressing concerns related to limited space, organization, or aesthetics.

### SUMMARY

The disclosure is directed to fiber optic terminals (hereinafter “terminals”) and compensation rings for adjusting a split ratio of fiber optic terminals including variable ratio couplers. The compensation rings and the terminals with variable ratio couplers allow the power levels for the optical outputs from the variable ratio coupler to be changed as desired, thereby providing flexibility for the network operators to adapt or customize their network for their given needs.

In one embodiment, a compensation ring for a variable ratio fiber optic coupler includes a ring body and at least one arcuate slot within the ring body operable to receive at least one locking fastener. The compensation ring also includes a shaft opening within the ring body, where the at least one arcuate slot at least partially surrounds the shaft opening, the shaft opening defines an inner surface, and the inner surface includes a plurality of detent receiving features. The compensation ring may be used with variable ratio couplers such as variable ratio couplers disposed in a fiber optic device or fiber optic terminal.

In another embodiment, a fiber optic terminal includes a shell defining a cavity, and a plurality of ports including a control port having a port opening extending from an outer surface of the terminal into the cavity and defining a port passageway along a longitudinal axis. The fiber optic terminal also includes a variable ratio coupler disposed within the cavity including a housing, an optical input, a first optical output, a second optical output, a shaft within the control port, a detent radially extending from the shaft, and a compensation ring disposed around the shaft. The compensation ring includes a ring body, at least one arcuate slot within the ring body operable to receive at least one locking fastener, and a shaft opening within the ring body. The compensation ring is secured to the housing by one or more locking fasteners. The at least one arcuate slot at least partially surrounds the shaft opening. The shaft opening defines an inner surface that includes a plurality of detent receiving features. Rotation of the shaft changes an output power level between the first optical output and the second optical output at a coupling region, and the detent is operable to be positioned in a selected detent feature of the plurality of detent features.

In another embodiment, a method of changing a split ratio of a fiber optic terminal includes inserting an axle of a tool into a control port passageway of a control port of a plurality of ports of the fiber optic terminal to engage an end of the axle with a shaft of a variable ratio coupler within a cavity of the fiber optic terminal, and rotating the axle of the tool to rotate the shaft of the variable ratio coupler to a desired split ratio set point of a plurality of split ratio set points. The desired split ratio set point corresponds to a desired output power level between a first optical output and a second optical output of the variable ratio coupler, and each split ratio set point is defined by a detent receiving feature of a plurality of detent receiving features of a compensation ring surrounding the shaft.

In another embodiment, a variable ratio coupler for changing a split ratio of optical power for two optical fibers includes a coupler having a coupling region operable to change the split ratio of the optical power for the two optical fibers. The variable ratio coupler also includes a housing. The variable ratio coupler further includes a shaft disposed within the housing that includes an end, a radially extending detent, an end face at the end configured to receive a tool, where rotation of the shaft by the tool changes an output power level between the first optical output and the second optical output at a coupling region. The variable ratio coupler further includes a compensation ring disposed around the shaft, the compensation ring having a ring body and at least one arcuate slot within the ring body. The variable ratio coupler also includes at least one locking fastener disposed within the at least one arcuate slot that secures the compensation ring to the housing and a shaft opening within the ring body, where the at least one arcuate slot is at least partially surrounds the shaft opening, the shaft opening defines an inner surface, and the inner surface includes a plurality of detent receiving features operable to receive the detent of the shaft. The variable ratio coupler also includes a cam disposed on the shaft, where the cam has a shape that changes an amount of bend on the coupling region for a desired split ratio of optical power for the two optical fibers. The plurality of detent receiving features corresponds to a plurality of split ratios of optical power.

In another embodiment, a method of assembling a variable ratio coupler includes positioning a compensation ring over a shaft such that a detent is positioned within a detent receiving feature corresponding to a first split ratio set point, inputting an optical signal into an optical input of the variable ratio coupler, measuring an optical power at a first optical output and a second optical output, turning the shaft until a split ratio of optical power between the first optical output and the second optical output is at the first split ratio optical power set point, and securing the compensation ring to a housing of the variable ratio coupler.

In another embodiment, a method of assembling a variable ratio coupler includes positioning a compensation ring over a shaft such that a detent is positioned within a detent receiving feature corresponding to a first split ratio set point, inputting an optical signal into an optical input of the variable ratio coupler, measuring an optical power at a first optical output and a second optical output, turning the shaft until a split ratio of optical power between the first optical output and the second optical output is at the first split ratio optical power set point, and recording the position of the shaft. The method also includes sequentially turning the shaft until the split ratio of optical power is at a plurality of split ratio set points and recording the position of the shaft at each individual split ratio set point of the plurality of split ratio set points. The method further includes removing the compensation ring from the shaft, fabricating a plurality of detent receiving features on the compensation ring according to the recorded positions of the shaft at the plurality of split ratio set points, and positioning the compensation ring over the shaft such that the detent is positioned within the dent receiving feature corresponding to the first split ratio set point. The method also includes inputting the optical signal into the optical input of the variable ratio coupler, measuring the optical power at the first optical output and the second optical output, turning the shaft until the split ratio of optical power between the first optical output and the second optical output is at the first split ratio optical power set point, and securing the compensation ring to a housing of the variable ratio coupler.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is a prior art multiport;

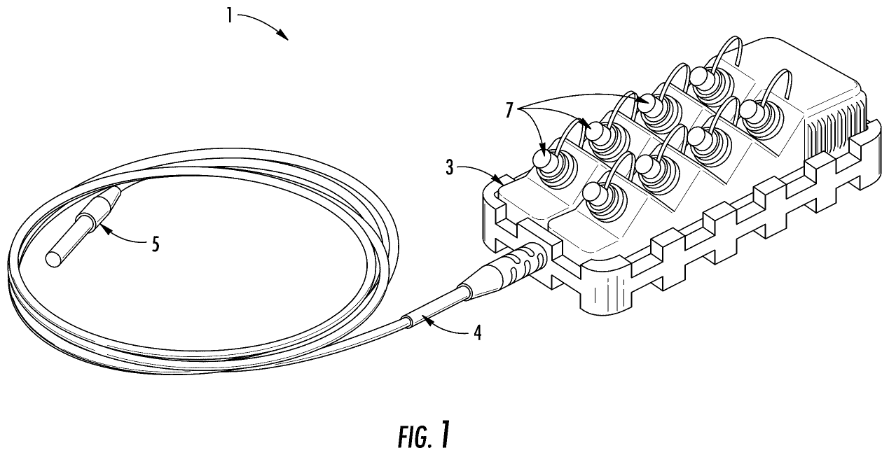

FIG. 2 is a schematic representation of a fiber optic network having terminals with a variable ratio coupler;

FIG. 3 is a schematic representation of the variable ratio coupler depicted in the terminals of FIG. 2;

FIG. 4 is a perspective view of an example fiber optic terminal comprising a variable ratio coupler controllable by a tool and with a plurality of output connection ports;

FIG. 5 is a partially exploded view of another explanatory terminal showing further details of a specific construction for terminals;

FIG. 6 is a transparent top view of another explanatory terminal showing further details of a specific construction for terminals;

FIG. 7 is a perspective view of an explanatory tool for changing an output power level between a first optical output and a second optical output;

FIG. 8 is a perspective view of an explanatory variable ratio coupler for receiving a tool to change an output power level between a first optical output and a second optical output;

FIG. 9 is a cross-sectional view of an explanatory variable ratio coupler for receiving a tool to change an output power level between a first optical output and a second optical output;

FIG. 10 is a front elevation view of an explanatory variable ratio coupler having a shaft and a compensation ring;

FIG. 11 is a front elevation view of another explanatory compensation ring;

FIG. 12 is a graph illustrating coupling ratio as a function of wavelength for a plurality of deflection values of a variable ratio coupler; and

FIG. 13 is a front elevation view of an explanatory cam profile of a shaft of a variable ratio coupler.

### DETAILED DESCRIPTION

References will now be made in detail to the embodiments of the disclosure, examples of which are illustrated in the accompanying drawings. Whenever possible, like reference numbers will be used to refer to like components or parts.

The concepts disclosed are related to fiber optic networks, tools and fiber optic terminals having at least one variable ratio coupler with shaft for actuation by a tool for changing an output power level between a first optical output and a second optical output for a passive optical network. As used herein, “variable ratio coupler” means that the output power level may be adjusted to many different power level splits (i.e., “split ratios”) across the spectrum of output power levels so that the power level split may be tuned or changed by the user as desired in a passive operation that does not require power to be supplied to the module for its operation, and does not mean the power level may only be changed to two discrete power level splits. Consequently, the fiber optic terminals (hereinafter “terminals”) comprising the variable ratio coupler(s) (hereinafter “VRC(s)”) are well-suited for passive optical networks such as in the outside plant environment such as downstream from a central office location or the like, but other applications are possible.

In addition to the passive operation and providing a wide range of possible output power split levels, the concepts using the VRC disclosed provide a stable performance across varying conditions. Further, the terminals and networks using the VRC have a low polarization dependent loss (PDL). In other words, the polarization state of the optical signal does not adversely impact the performance of the terminals or networks. Thus, the polarization state of the optical signal is not a factor for performance or operation. By way of example, the PDL loss is about 0.5 dB or less, and may even be as low as 0.3 dB or less or 0.2 dB or less for any polarization state of the input optical signal.

Still further, terminals and networks using the VRC have a wide wavelength range for suitable performance. By way of example, the terminals and networks using VRC comprise a similar performance from about 1260 nm to about 1625 nm. Generally speaking, the terminals disclosed and explained in the exemplary embodiments are multiports, but the concepts disclosed may be used with any suitable terminal such as closures, network interface devices, wireless radios or the like having at least one variable ratio coupler with a control for changing an output power level.

The concepts disclosed advantageously provide flexibility for the network operators and also reduce manufacturing complexity and inventory concerns for manufacturers of the terminals along with network operators since the need to manufacture and stock a multitude of terminals having different fixed power split levels is not necessary. In other words, the terminals and fiber optic networks disclosed may be adjusted to have the desired power level splits at any point during their lifetime, thereby providing flexibility and adaptability to alter the fiber optic network based on moves, adds or changes to the fiber optic network. The concepts may be used with any suitable terminals and may be especially advantageous with terminals having compact form-factors. The concepts are scalable to any suitable count of input or outputs on a terminal in a variety of arrangements or constructions for building fiber optic networks.

For instance, the concepts disclosed herein are suitable for fiber optic networks such as for Fiber-to-the-Home and 5G applications and are equally applicable to other optical applications as well including indoor, industrial, wireless, or other suitable applications. The concepts disclosed herein are especially advantageous for asymmetric split fiber optic networks (e.g., fiber optic networks having one VRC with an unequal output power level split). Additionally, the concepts disclosed may be used with terminals having any suitable footprint or construction.

Although VRC fiber optic terminals are desirable, providing the mechanisms to adjust the split ratio of the VRC in each fiber optic terminal may undesirably increase the cost of the fiber optic terminal. For example, more parts need to be fabricated and incorporated into the fiber optic terminal, thus increasing its cost of manufacture. Embodiments of the present disclosure reduce the overall cost to manufacture a fiber optic terminal having a VRC by including at least some of the mechanics for adjusting the split ratio of VRCs into a separate tool. Thus, a single tool may be used to adjust the split ratio of many fiber optic terminals. For example, the set-point display may be incorporated into the tool itself, as well as the mechanical means to adjust a coupling region of the VRC.

The embodiments described herein also enable a manufacturer of telecommunications equipment to replace multiple SKUs, each representing a terminal with a non-variable coupler with a fixed tap ratio, with a single SKU number for the fiber optic terminal having a VRC. This further reduces the costs to manufacture, purchase and manage fiber optic terminals incorporating couplers.

Various designs, constructions, or features for fiber optic networks, tools and terminals are disclosed in more detail as discussed herein and may be modified or varied as desired.

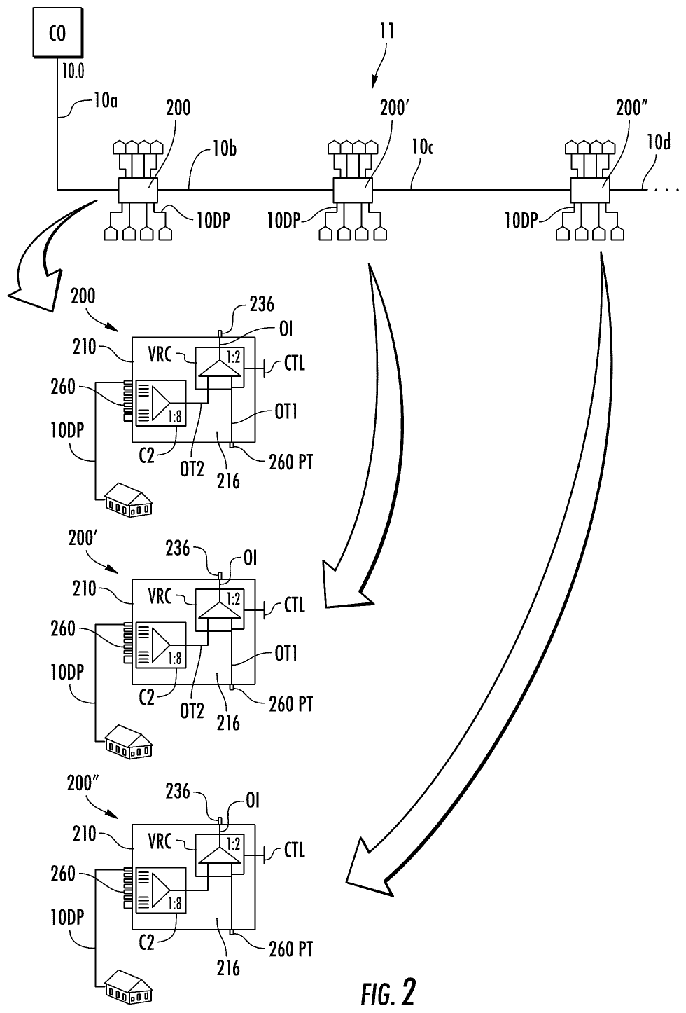

FIG. 2 shows a schematic view of an explanatory fiber optic network 11 such as for a passive fiber-to-the-home (FTTH) network comprising a first terminal 200 having a VRC; however, the concepts may be used with other networks such as a PON, FTTx or 5G networks. As depicted, a first optical link 10a (e.g., a first fiber optic cable) is an input optical link connected to a central office CO at a first end and a second end is in optical communication with the optical input OI of the first terminal 200. A first end of a second optical link 10b (e.g., a second optical cable) is an output optical link of terminal 200 and is in optical communication with the first optical output (OT1) of the terminal 200 as depicted. A second end of the second optical link 10b is in optical communication with the optical input OI of a second terminal 200′. A first end of a third optical link 10c (e.g., a third optical cable) is an output optical link of terminal 200′ and is in optical communication with the first optical output (OT1) of the terminal 200′ as depicted. A second end of the third optical link 10c feeds into the optical input OI of a third terminal 200″. A first end of a fourth optical link 10d (e.g., a fourth optical cable) is an output optical link of terminal 200″. The fiber optic network 11 splits the power level launched from the CO at the respective terminals 200, 200′ and 200″ for the distribution of optical signals to the fiber optic network 11.

Terminals 200, 200′ and 200″ are schematically depicted in FIG. 2 each of which comprises a shell 210 having a cavity 216 with a portion of the respective VRCs being disposed within the respective cavities 216. The terminals 200, 200′ and 200″ also comprise at least one input connection port 236, and a plurality of ports 260. The VRCs each also comprise the optical input (OI), the first optical output (OT1), the second optical output (OT2) and a control (CTL) for changing an output power level between the first optical output (OT1) and the second optical output (OT2) as depicted. The input connection port 236 may comprise a port opening 238 extending from an outer surface (234) of the terminal 200 into the cavity 216 and defines a port passageway 233 along a longitudinal axis. In this embodiment, terminals 200, 200′ and 200″ of fiber optic network 11 comprise the same configuration as depicted; however, the VRCs are adjusted with different output power level split between the respective first optical output (OT1) and second optical output (OT2) using the control (CTL). As described in more detail below, the control (CTL) may be adjusted using a tool, and further the control (CTL) may be provided within one of the optical ports of the terminal 200, 200′, 200″. The output power level split for the VRC may be asymmetric or not depending on the desired output power levels.

By way of explanation, fiber optic network 11 distributes the signal from the second optical output (OT2) from the respective VRCs to each local neighborhood where the bandwidth of the optical output is shared by multiple subscribers. For instance, terminal 200 may have its VRC adjusted to a 90/10 split of the power received from the central office (CO) (minus losses) with 90% of the input power being directed to the first optical output (OT1) and 10% of the input power being directed to the second optical output (OT2) for the distribution of optical signals to its local neighborhood. Thereafter, terminal 200′ receives 90% of the power transmitted to its optical input (OI) (minus losses such as connector losses, transmission losses, etc.), and may have its VRC adjusted to a 75/25 split of the power received at its optical input (OI) with 75% of the input power to terminal 200′ being directed to its first optical output (OT1) and 25% of the input power being directed to its second optical output (OT2) for the distribution of optical signals to its local neighborhood. Terminal 200″ that receives 75% of the power from the optical output (OT1) of terminal 200′ at the optical input (OI) may have its VRC adjusted to a 50/50 split of the power received with 50% of the input power being directed to the first optical input (OT1) and 50% of the input power being directed to the second optical output (OT2) for the distribution of optical signals to its local neighborhood. This representative fiber optic network 11 allows the desired power levels to be transmitted to the local neighborhoods, while transmitting the remaining power downstream in the fiber optic network 11 as desired. Moreover, the output power level split ratios within the terminals 200, 200′ and 200″ may be easily and quickly adjusted by the network operator as needed for moves, adds or changes in the fiber optic network 11 as desired, thereby providing flexibility and adaptability that is lacking in conventional fiber optic networks.

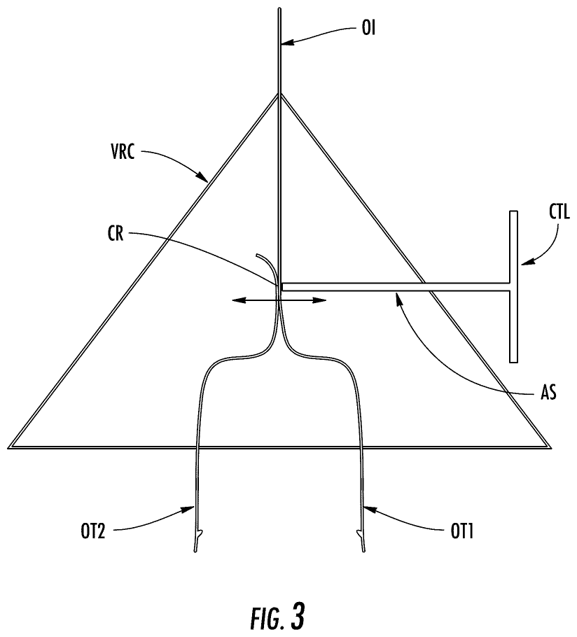

FIG. 3 is a schematic representation of the VRC depicted in terminals 200, 200′ and 200″. As depicted, VRC comprises an optical input (OI) that has its output power level split between the first optical output (OT1) and the second optical output (OT2) at a coupling region (CR), with the control (CTL) for changing the output power level between the first and second outputs (OT1,OT2). The coupler may be a planar lightwave circuit (PLC) or multiclad coupler (MC) as known in the art, but other suitable structures may be used. The optical input (OI) and the optical outputs (OT1, OT2) are optical waveguides such as optical fibers that may be in optical communication with the respective input and outputs of the planar lightwave circuit or other type of device. Control (CTL) may be actuated (e.g., by use of a tool) for changing the output power level between the first optical output (OT1) and the second optical output (OT2) by any suitable means at the coupling region (CR).

The coupling region (CR) is the region where a portion of the first optical waveguide of the first optical output (OT1) and a portion of the second optical waveguide of the second optical output (OT2) are in optical (e.g., intimate) contact for allowing the changing of the output power level of the optical signals transmitted by the first optical output (OT1) and the second optical output (OT2). More specifically, the control (CTL) is configured for individually moving a portion of the first optical waveguide of the first optical output (OT1) (or alternatively moving a portion of the second optical waveguide of the second optical output (OT2)) at the coupling region (CR) as represented by the horizontal line with the arrows on the ends. The individual movement of the first or second optical waveguide with the control (CTL) may bend, deflect or change the geometry between the portion of the first optical waveguide of the first optical output (OT1) and the portion of the second optical waveguide of the second optical output (OT2) at the coupling region (CR) (i.e., an amount of deflection of the coupling region) for changing the output power level of the optical signals transmitted by the first optical output (OT1) and the second optical output (OT2). In further embodiments, the portion of the first optical waveguide and the portion of the second optical waveguide are fused together at the coupling region (CR) and the coupling ratio may be changed, for example, by bending the fused region. Other constructions are possible for the coupling region (CR) for changing the output power level of the optical signals transmitted by the first optical output (OT1) and the second optical output (OT2). For instance, other embodiments may change the index of refraction of the materials in or around the coupling region (CR). It should be understood that embodiments described herein are not limited by the method of changing the coupling ratio, such as those described in U.S. Pat. No. 7,627,214, for example.

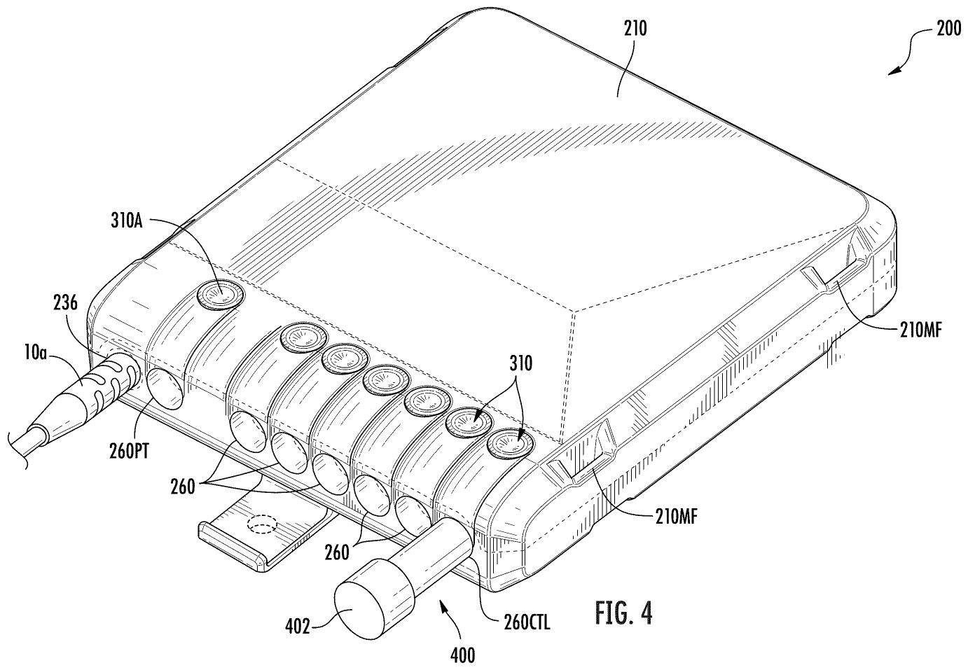

FIG. 4 depicts an explanatory terminal 200 that comprises at least one input connection port 236 and a pass-through connection port 260PT. Input connection port 236 and pass-through output connection ports 260PT are suitable for receiving respective external fiber optic connectors 100 of the optical link 10a. In this construction, the terminal 200 comprises an optical link 10a configured as a fiber optic cable that is secured to the input connection port 236 as a tether cable and optically connected to the optical input (OI) of the VRC. In other words, the fiber optic cable is not intended to be removable from the input connection port 236. The other end of the tether cable may be terminated with a suitable fiber optic for optical connectivity to the fiber optic network.

On the other hand, the pass-through connection port 260PT of terminal 200 of FIG. 4 is in optical communication with the first optical output (OT1) of the VRC. Terminal 200 of FIG. 4 also comprises a second coupler (C2) in optical communication with the second optical output (OT2) of the VRC such as schematically depicted in FIG. 2. The second optical coupler (C2) comprises a plurality of second coupler outputs (C201-C20x), and the second coupler outputs (C201-C20x) are in optical communication with a plurality of optical connection ports 260. More specifically, the second coupler outputs may comprise optical fibers extending from a PLC that are optically connected or terminated with respective fiber optic connectors 252 disposed within the cavity 216 of the terminal and are aligned with the respective port 260 for optical connection with the terminal 200. Terminal 200 of FIG. 4 comprises six output connection ports 260, but terminals 200 may use any suitable number of output connection ports as desired. The output connection ports 260 may be optically connected to drop cables having a suitable connector for routing the optical signals toward the subscribers.

In the embodiment of FIG. 4, the control port 260CTL is provided as an optical port opening such that it is within an array of output connection ports 260. Such a placement for the 260CTL may be advantageous because special shells do not need to be molded specifically for terminals including a VRC. Thus, one SKU number may be provided for shells intended for variable split ratio terminals and for shells intended for fixed split ratio terminals. As described in more detail below, the split ratio of the terminal 200 is adjusted by inserting a tool into the control port 260CTL. Another advantage of the embodiment shown by FIG. 4 is that the same plugs can be used for the control port 260CTL as the output connection ports 260.

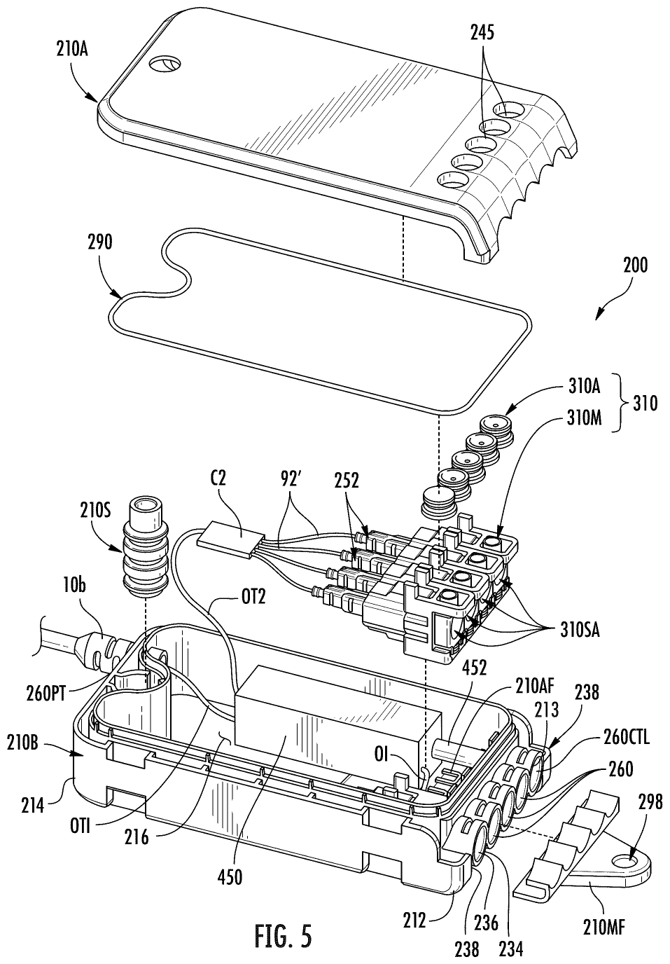

In further explanation the terminal 200 of FIGS. 4-6 comprises a shell 210 with a cavity 216 along with a securing feature 310 comprising a securing member 310M associated with the port passageway 233 (FIG. 5). The input connection port 236, and pass-through connection ports 260PT each comprise a port opening extending from an outer surface of the terminal 200 into the cavity 216 of the terminal 200 and each port respectively defines a port passageway along a longitudinal axis. Each port 236, 260PT has a respective securing member 310M associated with the port. Each securing member 310M comprises a bore 310B suitable for receiving and securing a portion of the housing 20 of the fiber optic connector of the respective optical link such as depicted with the input optical link 10a inserted into the input connection port 236. Likewise, the output connection ports 260 where used may have a similar construction as described for the input connection port 236 and pass-through connection ports 260PT. Terminals 200 may also advantageously use the securing members 310M for releasably connecting the external fiber optic connectors 100 of the optical links in the respective connection ports using an actuator 310A of securing feature 310.

As stated above, the split ratio provided by a variable ratio coupler within the terminal is adjusted by a tool that is inserted into the cavity 216 of the shell 210. FIG. 5 illustrates a VRC 450 within the cavity 216 according to one embodiment. The VRC 450 is accessible by a control port 260CTL that is configured as an output port and is in an array of output ports 260. The control port 260CTL is defined by a passageway extending from an edge of the shell 210 into the cavity. As described in more detail below, the control port 260CTL is operable to receive a tool that engages a shaft 452. FIG. 4 illustrates an example tool 400 positioned in a control port 260CTL. Rotation of the tool 400 causes rotation of the shaft 452, which in turn causes the coupling region within the VRC 450 to bend. The bending of the coupling region changes the output power level of optical outputs OT1 and OT2 and thus changes the split ratio between optical outputs OT1 and OT2.

FIG. 4 illustrates a tool 400 inserted into a control port 260CTL. Particularly, the tool 400 comprises an axle 402 and an end piece, which is configured as a knob 401 in the illustrated embodiment. The user inserts the axle 402 into the passageway of the control port 260CTL until it engages the VRC. The user then applies a rotational force to the knob 401, which rotates the axle 402 and a shaft of the VRC to change the split ratio as described in more detail below.

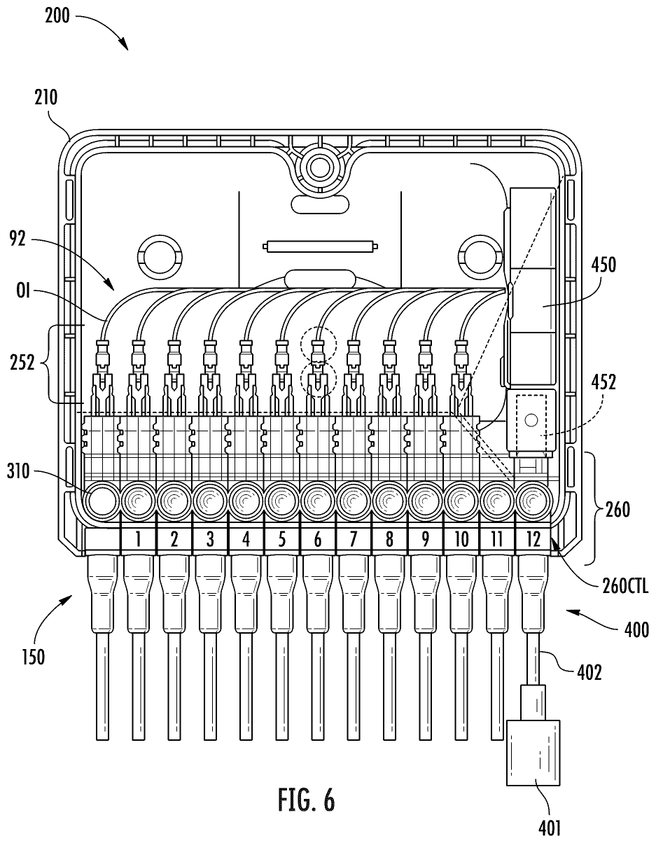

FIG. 6 illustrates a partially transparent top view of a terminal 200 showing internal components of the terminal 200. Rather than a rear connector 252 at port #12, the terminal includes a VRC 450 at port #12. When inserted into the control port 260CTL (i.e., port 12), the tool 400 engages the VRC 450 and enables the user to change the split ratio of the terminal 200 accordingly.

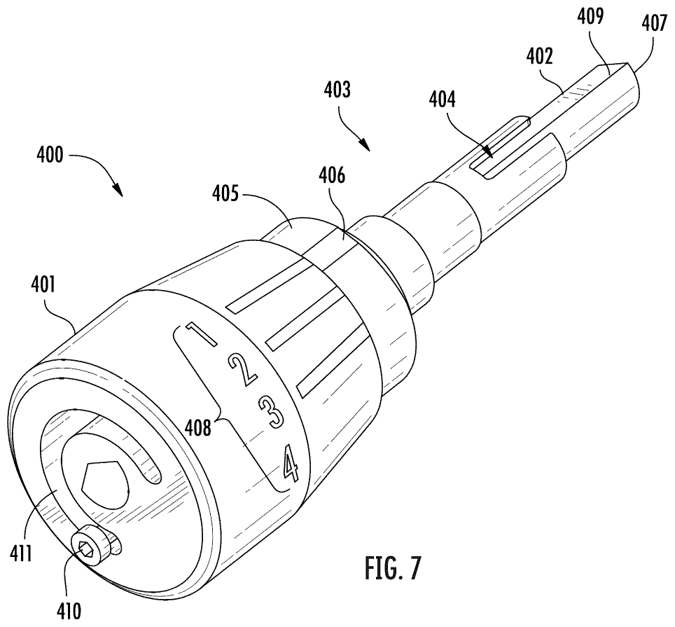

FIG. 7 illustrates a non-limiting example of a tool 400 for adjusting a split ratio of a terminal 200. The example tool 400 includes an axle 402 for insertion into a port (i.e., a control port 260CTL) of a fiber optic terminal. An end 407 of the axle 402 is rotationally asymmetric such that it is insertable into the VRC in only one rotational orientation. The phrase “rotationally asymmetric” means a component has only one rotational orientation with respect to another component. In the embodiment of FIG. 7, the end 407 includes a peak edge 409 such that the peak edge may only be inserted into a similarly shaped notch within the VRC.

The tool 400 further includes a terminal engagement body 403 disposed about the axle 402. The axle 402 is free to at least partially rotate about the terminal engagement body 403. The terminal engagement body 403 includes a terminal engagement feature 404 for engaging a corresponding alignment feature of the terminal 200. In the illustrated embodiment, the terminal engagement feature 404 is configured as a notch that is operable to engage an alignment feature configured as a protrusion, such as a ledge or a post. FIG. 5 illustrates an example alignment feature 213 configured as a ridge-like protrusion within the passageway defined by the control port 260CTL. Thus, the terminal engagement feature 404 and the alignment feature 213 cooperate to index the terminal engagement body 403 to a known position with respect to the terminal 200 and thus the VRC. It should be understood that other configurations for the terminal engagement feature 404 and the alignment feature 213 are possible.

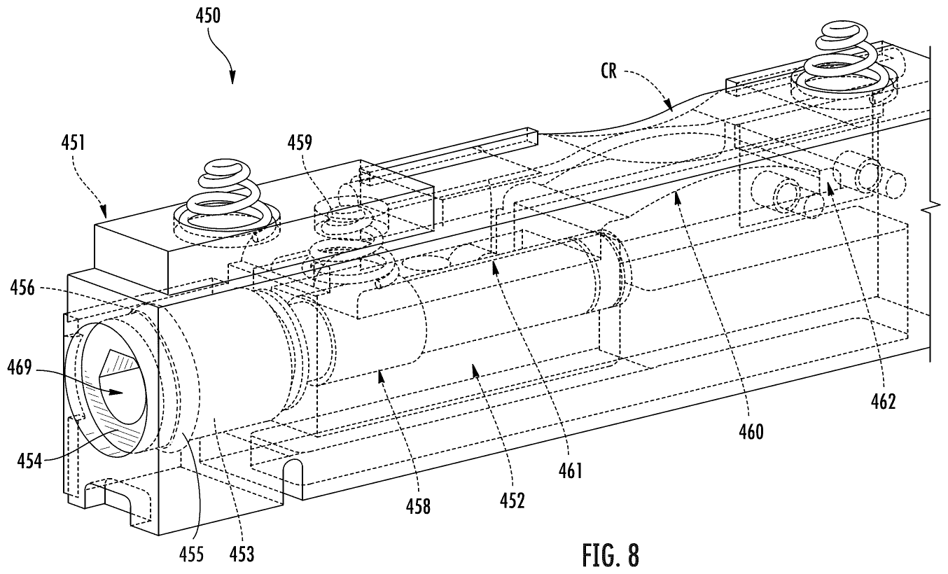

Referring once again to FIG. 8 the terminal engagement feature 404 further comprises a set-point portion 405 that includes a set-point indicator 406. The set-point indicator 406 is referenced to the terminal engagement feature 404. As a non-limiting example, the set-point indicator 406 is aligned with the terminal engagement feature 404 along a longitudinal axis of the tool 400. The illustrated set-point indicator 406 is a ridge formed within the set-point portion 405. However, in other embodiments the set-point indicator 406 may be a marking, for example (e.g., an arrow, a line, a circle, etc.).

The tool 400 also includes an end piece configured as a knob 401 that is rigidly coupled to the axle 402. Rigidly coupled means that the knob 401 is not free to rotate with respect to the axle 402. The knob 401 has the function of providing a means for the user to rotate the tool 400 as well as providing a read-out of the current set-point of the terminal 200. Although FIG. 8 illustrates the end piece as a knob 401, embodiments are not limited thereto.

The knob 401 includes a plurality of set-point markers 408 that indicate which set-point (i.e., what split ratio) the terminal 200 is presently set at. In the illustrated embodiment, the set-point markers 408 comprise lines and associated numbers indicating the set-point. Embodiments are not limited to any particular marker for the set-point markers. For example, in another embodiment, the numbers may be replaced by the actual split ratio of the particular set point (e.g., 90/10, 75/25, and the like).

The terminal engagement body 403 is also free to rotate with respect to the knob 401 because the knob 401 is rigidly coupled to the axle. The knob 401 may be rotatably coupled to the terminal engagement body 403 by any manner. In the illustrated embodiment, the knob 401 includes an arcuate slot 411 extending from a face of the knob 401 into a passageway defined by the knob 401. An attachment feature 410 extends from an end face of the terminal engagement body 403 that is disposed within the passageway of the knob 401. The attachment feature 410 extends through the slot and prevents the knob 401 from being pulled away from the terminal engagement body 403. As a non-limiting example, a small screw may be applied to the attachment feature 410 after the attachment feature is positioned through the slot 411 to prevent the knob 401 from being separated from the terminal engagement body 403. The attachment feature 410 and the slot 411 prevent longitudinal movement of the knob 401 while allowing rotational movement of the knob 401 and axle 402 with respect to the terminal engagement body 403. Attachment feature 410 also provides limit on the rotational amount of knob 401 and said feature is not typically separable in normal use.

Upon insertion of the tool 400 into a control port 260CTL, the terminal engagement feature 404 engages the alignment feature 213 (FIG. 5) associated with the terminal 200. This orients the terminal engagement feature 404 to a proper and known position with respect to the terminal 200. Thus, the set-point indicator 206 is in a measurement position with respect to the terminal.

As the user continues to insert the tool 400 into the control port 260CTL, the end 407 of the axle 402 reaches a shaft 452 (FIG. 8) of the VRC. Because the end 407 of the axle 402 is rotationally asymmetric, it can only be inserted into the shaft 452 of the VRC in one rotational orientation. The user may need to rotate the knob 401 to find the proper orientation of the axle 402 with respect to the shaft 452. Once the axle 402 is properly seated in the shaft 452, the user may turn the knob 401, which also turns the axle 402 and the shaft 452, to align the desired set-point marker of the plurality of set-point markers 408 to the set-point indicator 406. It should be understood that all possible embodiments of the shaft 407 are not shown but the concept is to discourage tampering by using a shape which though available from vendors in the telecom space is not commonly available to members of the public.

Referring now to FIG. 8, a non-limiting example of a VRC 450 is illustrated. The VRC 450 includes a housing 451 that defines a cavity in which the internal components are disposed. It should be understood that embodiments are not limited to the particular VRC 450 illustrated by FIG. 8, and that VRCs of the present disclosure may include different components or differently arranged components.

The VRC 450 includes a shaft 452 extending into the cavity defined by the housing 451. The shaft 452 includes an end face 454 that is accessible through an opening of the housing 451. The end face 454 is on a set-point portion 453 of the shaft 452. The shaft 452 further includes a cam 458, as described in more detail below. The shaft 452 further includes a rotationally asymmetric feature so that the axle 402 may be coupled to the shaft 452 in only one rotational position. In the illustrated embodiment, the rotationally asymmetric feature is a single hole 469 or opening that is rotationally asymmetric. The hole 469 is circular in shape but also includes a peak edge notch that is configured to receive a peak edge of the axle 402 in only one orientation. Embodiments are not limited to any particular rotationally asymmetric feature

The VRC 450 further includes a flexure 460 that is held down on one side by a bias member 459 configured as a spring. The other side of the flexure 460 contacts a surface of the cam 458. An end 462 of the flexure 460 that is opposite from the end 461 that contacts the shaft 452 is rigidly coupled to the housing 451. An amount of bend on the coupling region (CR) imparted by the flexure 460 determines the amount of optical power that is provided to a first output OT1 and to a second output OT2 and thus determines the split ratio. The cam 458 is designed such that different positions on the surface of the cam 458 provide differing amounts of bend on the coupling region (CR).

During use, an operator will use a tool or otherwise turn the shaft 452 to a position that corresponds with a desired set point. The VRC 450 is configured to snap into discrete set points as the shaft 452 is turned. Haptic feedback is provided to the operator when a set point is reached. In embodiments of the present disclosure, the set points and corresponding haptic feedback are provided by a compensation ring 455 that is disposed around a set point portion 453 of the shaft 452.

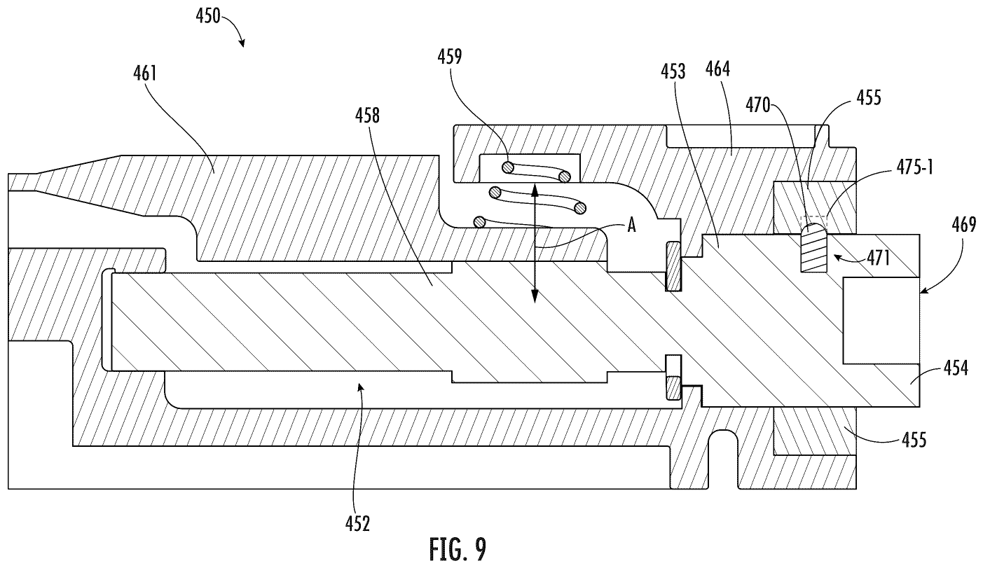

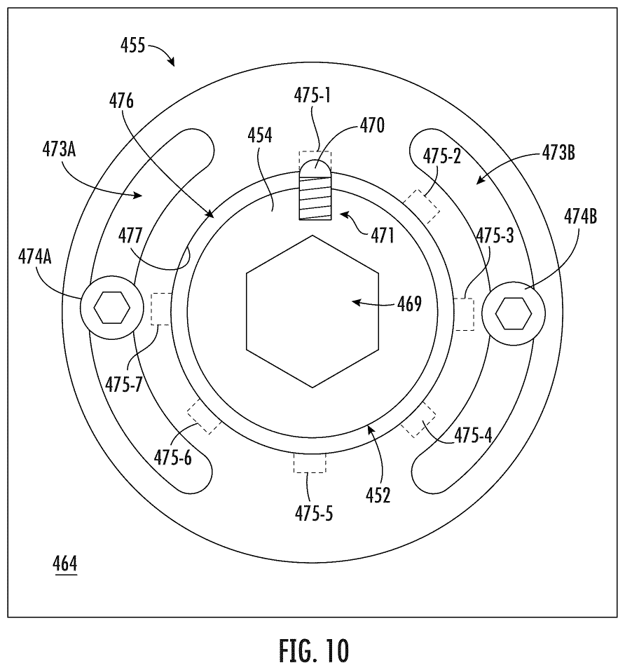

FIGS. 9 and 10 illustrate a VRC 450 including a compensation ring 455. FIG. 9 is a cross-sectional view of the VRC 450 while FIG. 10 is a front close-up view of the compensation ring and VRC 450. The compensation ring 455 is disposed around the front end 454 of the shaft 452 such that the shaft 452 is free to rotate with respect to compensation ring 455. The shaft 452 further includes a radially extending detent 470. As a non-limiting example, the detent 470 may be configured as a ball detent. The detent 470 may be biased by a bias member 471, for example. The bias member 471 may enable the detent 470 to be pushed in a direction toward the surface of the shaft 452 by an external force. The detent 470 is operable to be positioned within one of a plurality of detent receiving features, which correspond to individual split ratio set points for the VRC. FIG. 9 illustrates the detent 470 disposed within a first detent receiving feature 475-1, which corresponds with a first split ratio set point.

Referring particularly to FIG. 10, the compensation ring 455 is circular in shape and operable to be positioned within a recess of a housing 464 of the VRC 450. The compensation ring 455 has a central shaft opening 476 that is operable to receive the front end 454 of the shaft 452. The shaft 452 is free to rotate within the shaft opening 476.

The compensation ring 455 further includes at least one arcuate slot that surrounds the shaft opening 476, which in the illustrated embodiment includes a pair of arcuate slots including a first arcuate slot 473A and a second arcuate slot 473B, each of which oppose one another. In other embodiments, there may be only a single arcuate slot. As described in more detail below, the arcuate slots enable rotation of the compensation ring 455 with respect to the housing 464 for calibration of the compensation ring 455 during a VRC assembly process.

The shaft opening 476 defines an inner surface 477 that faces the exterior surface of the shaft 452. A plurality of detent receiving features 475 are located within the inner surface 477. The detent receiving features 475 are configured as recesses into which the detent 470 of the shaft 452 may be positioned. The example compensation ring 455 includes a first detent receiving feature 475-1, a second detent receiving feature 475-2, a third detent receiving feature 475-3, a fourth detent receiving feature 475-4, a fifth detent receiving feature 475-5, a sixth detent receiving feature 475-6 and a seventh detent receiving feature 475-7 (collectively referred to herein as detent receiving features 475). It should be understood that embodiments are not limited by the number of detent receiving features 475. The detent receiving features 475 may be blind bores as illustrated by FIG. 10, or through holes.

Each detent receiving feature 475 corresponds to a particular set-point marker on the knob 401 and thus a particular split ratio set point (e.g., 90/10, 75/25 etc.). Thus, the plurality of detent receiving features 475 correspond to a plurality of split ratio set points of the VRC 450. As stated above, the VRC 450 further includes a detent that is biased toward the inner surface 477 by a bias member 471, such as a coil spring, for example. In other embodiments no bias member is provided. As the shaft 452 is turned by the tool 400, the detent 470 is seated and then exits the detent receiving features 475. The detent 470 and the detent receiving features 475 provide haptic feedback to the operator so that the operator knows when the detent 470 is properly seated in a detent receiving feature 475 (e.g., a click or a vibration may be felt by the user through the tool 400 when the detent 470 enters a detent receiving feature 475). Further, it will require more force by the user to turn the knob 401 to cause the detent 470 to exit the detent receiving feature 475 as compared to when the detent 470 is not present within a detent receiving feature 475. In other words, a resistance to rotate the tool 400 is increased when the detent 470 is within a detent receiving feature 475 to move the detent 470 out of the detent receiving feature 475. Additionally, the placement of the detent 470 within a detent receiving feature 475 ensures that shaft 452 is locked at the desired rotational position and split ratio set-point.

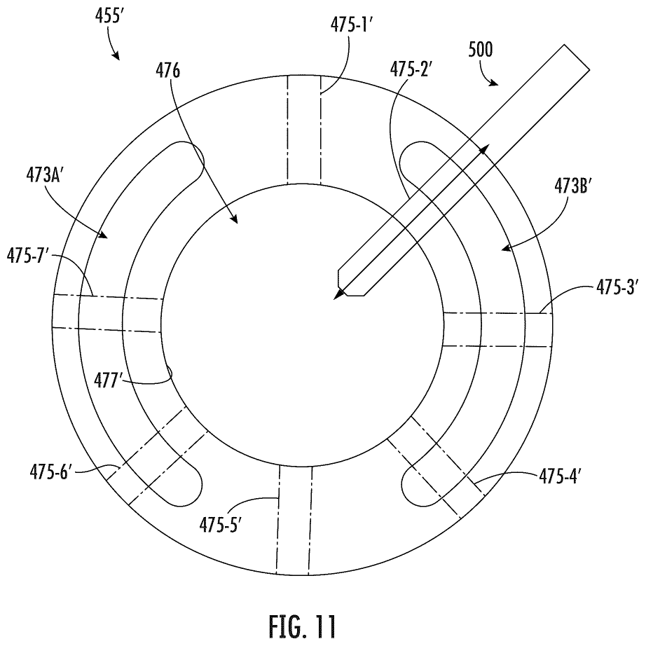

The compensation ring 455 is fabricated such that each detent receiving feature 475 corresponds with an individual split ratio set point as determined by the rotational position of the shaft 452. The spacing between individual detent receiving features may be determined by a calibration process. Once the proper locations of the detent receiving features 475 are known, the compensation rings 455 may be fabricated, such as by injection molding, for example. The compensation ring 455 shown in FIG. 10 is universal and mass produced. As described in detail below with respect to FIG. 11, in other embodiments the positions of the detent receiving features 475 may be determined for each individual VRC, thereby providing a specialized compensation ring 455′ for each individual VRC that is more precise than a universal compensation ring 455.

The compensation ring 455 should be rotationally positioned within the VRC 450 at a known reference position such that the plurality of detent receiving features correspond with the proper plurality of split ratio set points. During an assembly process, a compensation ring 455 is disposed on a shaft 452 of the VRC 450 such that the shaft 452 is positioned through the shaft opening 476 of the compensation ring 455, and the detent 470 is positioned within the first detent receiving feature 475-1. One or more fasteners are then positioned within the one or more arcuate slots, such as a first fastener 474A within a first arcuate slot 473A and a second fastener 474B within a second arcuate slot 474B. The front face of the housing 464 includes threaded holes (not shown) to receive the one or more fasteners. The one or more fasteners are loosely threaded to the one or more threaded holes but not fully tightened so that the compensation ring 455 rotates with the shaft 452.

An optical signal (e.g., laser light) is inputted into the optical input OI of the VRC 450, and the optical power at both the first optical output OT1 and the second optical output OT2 are measured. The shaft 452 is turned until the optical power of the first optical output OT1 and the second optical output OT2 provide a split ratio that is at the first split ratio set point (e.g., 90/10). Next, the compensation ring 455 is secured to the housing 464 by tightening the one or more fasteners, such as the first fastener 474A and the second fastener 474B of FIG. 10. Now the locations of the detent receiving features 475 are properly indexed to the positions of the shaft 452 that produce split ratios corresponding to the desired split ratio set points. The operator may then use the tool to rotate the shaft 452 such that the detent 470 is seated in the detent receiving feature 475 associated with the desired split ratio set point.

FIG. 11 illustrates an example compensation ring 455′ that is calibrated and fabricated for use with a specific VRC 450. A specifically calibrated compensation 455′ may provide more precise split ratios than the mass-produced compensation ring 455 of FIG. 10. A drill bit 500 or other material removing tool is used to fabricate through holes within the compensation ring 455′ body that correspond with the precision locations of split ratio set points for the intended VRC 450. These holes define the plurality of detent receiving features, such as a first detent receiving feature 475-1′, a second detent receiving feature 475-2′, a third detent receiving feature 475-3′, a fourth detent receiving feature 475-4′, a fifth detent receiving feature 475-5′, a sixth detent receiving feature 475-6′ and a seventh detent receiving feature 475-7′ (collectively referred to herein as detent receiving features 475′). It should be understood that any number of detent receiving features 475′ may be utilized depending on the number of desired split ratio set points.

To determine the proper location for the detent receiving features, an optical signal (e.g., laser light) is inputted into the optical input OI of an individual VRC 450, and the optical power at both the first optical output OT1 and the second optical output OT2 are measured. The shaft 452 is turned until the optical power of the first optical output OT1 and the second optical output OT2 provide a split ratio that is at the first split ratio set point (e.g., 90/10). The position of the shaft 452 that provides the first split ratio set point is then recorded. The shaft 452 is then turned until the optical power of the first optical output OT1 and the second optical output OT2 provide a split ratio that is at the second split ratio set point (e.g., 80/20). The position of the shaft 452 that provides the second split ratio set point is then recorded. This process is continued until the positions of the shaft 452 corresponding to all of the desired split ratio set points are determined and record.

Next, the detent receiving features 475′ corresponding to the recorded positions of the individual VRC 450 are fabricated in the compensation ring 455′. For example, a drill bit 500 or other tool is used to fabricate through holes at the recorded positions that define the detent receiving features 475′. In another embodiment, a compensation ring 455′ having detent receiving features 475′ at the recorded positions is fabricated by three-dimensional printing. Other methods for fabricating the compensation ring 455′ may be utilized. The detent receiving features 475′ may be through holes or blind bores, for example.

The specialized compensation ring 455′ may then be assembled to the VRC 450 by the same process as described about with respect to FIG. 10.

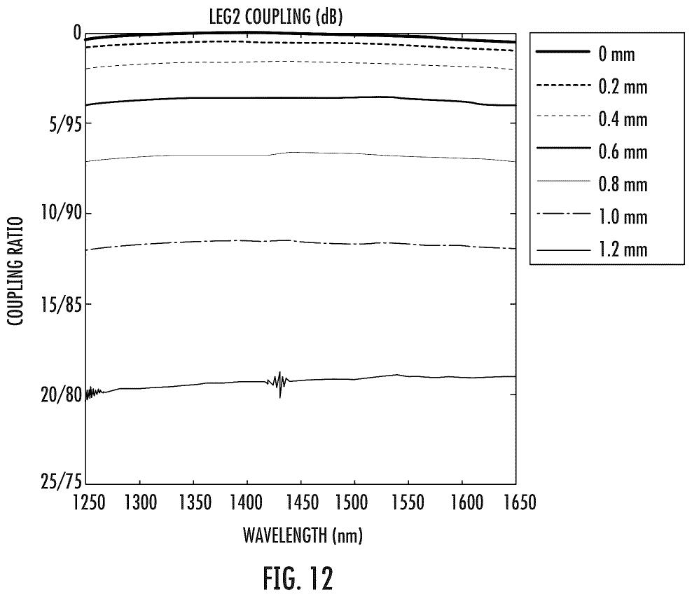

FIG. 12 illustrates plots of the coupling ratio as a function of wavelength (nm) for a plurality of deflection position values of the coupling region CR. Each detent receiving feature 475 may correspond with a desired coupling ratio set point.

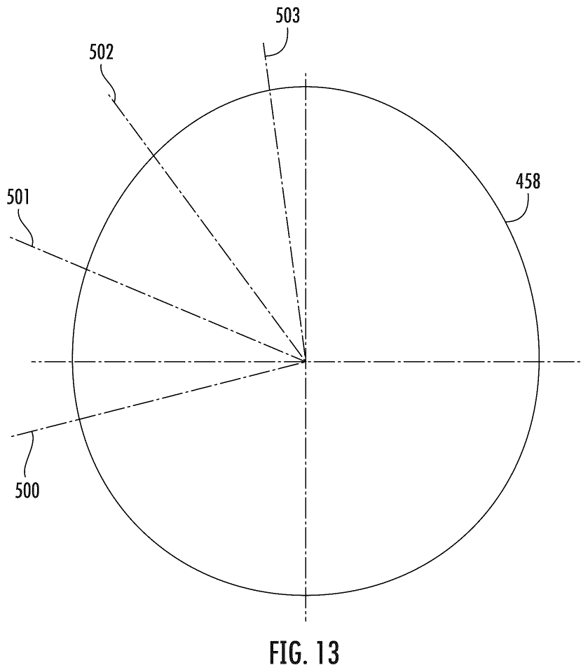

As stated above, the shaft 452 includes a cam 458 having a shape profile to impart various deflection values on the flexure 460 and thus the coupling region CR of the waveguide of the VRC 450. FIG. 13 illustrates an example shape profile of a cam 458. Line 500 represents the set point corresponding to the pre-molded reference position of the first detent receiving feature 475-1, line 501 represents the set point corresponding to the second detent receiving feature 475-2, line 502 represents the set point corresponding to the third detent receiving feature 475-3, and line 503 represents the set point corresponding to the fourth detent receiving feature 475-4.

Due to the nature of the cam profile, the 0 mm deflection position (i.e., corresponding with the first detent receiving feature 475-1) may be achieved with a range of rotational values, whereas the preset coupling ratios only exist at a discrete rotary position, thus the location of the “0 deflection” position is forgiving and may be pre-molded for both the fully molded compensation ring and the drilled variant.

As stated above, the compensation ring 450 should be installed such that the tap ratio output is set to the first set point prior to locking the ring. The deviation in deflection from the first set point to the second set point, and so on, may be consistent in devices of this type; however due to variations in manufacturing of the camshaft, camshaft housing, and mating surfaces it cannot be assumed that the deviation from the “no deflection point” of the first set point is consistent between manufactured devices.

For the purposes of describing and defining the present invention it is noted that the terms “approximately” and “substantially” are utilized herein to represent the inherent degree of uncertainty that may be attributed to any quantitative comparison, value, measurement, or other representation. The terms “approximately” and “substantially” are also utilized herein to represent the degree by which a quantitative representation may vary from a stated reference without resulting in a change in the basic function of the subject matter at issue.

It is noted that recitations herein of a component of the present invention being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. For instance, the connection port insert may be configured as individual sleeves that are inserted into a passageway of a device, thereby allowing the selection of different configurations of connector ports for a device to tailor the device to the desired external connector. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A fiber optic terminal comprising:
a shell comprising a cavity;
a plurality of ports comprising a control port having a port opening extending from an outer surface of the terminal into the cavity and defining a port passageway along a longitudinal axis; and
a variable ratio coupler disposed within the cavity, the variable ratio coupler comprising a housing, an optical input, a first optical output, a second optical output, a shaft within the control port, a detent radially extending from the shaft, and a compensation ring disposed around the shaft, wherein:
the compensation ring comprises a ring body, at least one arcuate slot within the ring body operable to receive at least one locking fastener, and a shaft opening within the ring body;
the compensation ring is secured to the housing by one or more locking fasteners;
the at least one arcuate slot is at least partially surrounds the shaft opening;
the shaft opening defines an inner surface;
the inner surface comprises a plurality of detent receiving features;
rotation of the shaft changes an output power level between the first optical output and the second optical output at a coupling region; and
the detent is operable to be positioned in a selected detent feature of the plurality of detent features.

2. The fiber optic terminal of claim 1, wherein the plurality of detent receiving features corresponds to a plurality of split ratio set points of the variable ratio fiber optic coupler.

3. The fiber optic terminal of claim 1, wherein the plurality of detent receiving features comprises a plurality of blind bores.

4. The fiber optic terminal of claim 1, wherein the plurality of detent receiving features comprises a plurality of through holes.

5. The fiber optic terminal of claim 1, wherein the at least one arcuate slot comprises a pair of arcuate slots.

6. The fiber optic terminal of claim 1, wherein the arcuate slots of the pair of arcuate slots oppose one another.

7. The fiber optic terminal of claim 1, wherein the plurality of ports further comprises:
at least one input connection port; and
a pass-through output connection port.

8. The fiber optic terminal of claim 1, wherein the plurality of detent receiving features correspond to a plurality of set points for the output power level between the first optical output and the second optical output.

9. The fiber optic terminal of claim 1, wherein:
the variable ratio coupler further comprises:
a cam positioned at a portion of the shaft; and
a flexure comprising a first end that contacts a portion of the cam and a second end that is held immobile in the variable ratio coupler; and
a coupler, wherein each end of the coupler is mounted to a different end of the flexure; and
rotation of the shaft causes the cam to change an amount of bend on the coupling region thereby changing the output power level between the first optical output and the second optical output at the coupling region.

10. The fiber optic terminal of claim 9, wherein rotation of the cam changes an amount of deflection on the first end of the flexure which also changes the amount of bend on the coupling region.

11. The fiber optic terminal of claim 1, wherein the plurality of ports are provided in an array at an end face of the shell.

12. A method of changing a split ratio of a fiber optic terminal, the method comprising:
inserting an axle of a tool into a control port passageway of a control port of a plurality of ports of the fiber optic terminal to engage an end of the axle with a shaft of a variable ratio coupler within a cavity of the fiber optic terminal; and
rotating the axle of the tool to rotate the shaft of the variable ratio coupler to a desired split ratio set point of a plurality of split ratio set points, wherein the desired split ratio set point corresponds to a desired output power level between a first optical output and a second optical output of the variable ratio coupler, and each split ratio set point is defined by a detent receiving feature of a plurality of detent receiving features of a compensation ring surrounding the shaft.

13. The method of claim 12, wherein the first optical output is provided at a first output connection port of the plurality of ports and the second optical output is provided at a second output connection port of the plurality of ports.

14. The method of claim 12, wherein the plurality of ports extend from an outer surface of a shell of the fiber optic terminal into the cavity defined by the shell.

15. The method of claim 12, wherein:
the compensation ring comprises a ring body, at least one arcuate slot within the ring body operable to receive at least one locking fastener, and a shaft opening within the ring body;
the compensation ring is secured to a housing by one or more fasteners;
the at least one arcuate slot is at least partially surrounds the shaft opening;
the shaft opening defines an inner surface; and
the plurality of detent receiving features are positioned at the inner surface.

16. The method of claim 15, wherein the plurality of detent receiving features corresponds to the plurality of split ratio set points of the variable ratio fiber optic coupler.

17. The method of claim 15, wherein the plurality of detent receiving features comprises a plurality of blind bores.

18. The method of claim 15, wherein the plurality of detent receiving features comprises a plurality of through holes.

19. The method of claim 15, wherein the at least one arcuate slot comprises a pair of arcuate slots.

20. The method of claim 19, wherein each arcuate slot of the pair of arcuate slots oppose one another.

21. The method of claim 12, wherein the plurality of ports further comprises:
at least one input connection port; and
a pass-through output connection port.

22. A variable ratio coupler for changing a split ratio of optical power for two optical fibers comprising:
a coupler comprising a first optical output, a second optical output, and a coupling region operable to change the split ratio of the optical power for the two optical fibers at the first optical output and the second optical output;
a housing;
a shaft disposed within the housing and comprising an end, a radially extending detent, an end face at the end configured to receive a tool, wherein rotation of the shaft by the tool changes an output power level between the first optical output and the second optical output at the coupling region;
a compensation ring disposed around the shaft, the compensation ring comprising:
a ring body;
at least one arcuate slot within the ring body;
at least one locking fastener disposed within the at least one arcuate slot that secures the compensation ring to the housing;
a shaft opening within the ring body, wherein:
the at least one arcuate slot is at least partially surrounds the shaft opening;
the shaft opening defines an inner surface; and
the inner surface comprises a plurality of detent receiving features operable to receive the detent of the shaft; and
a cam disposed on the shaft, wherein the cam has a shape that changes an amount of bend on the coupling region for a desired split ratio of optical power for the two optical fibers, and the plurality of detent receiving features corresponds to a plurality of split ratios of optical power.

23. The variable ratio coupler of claim 22, wherein the plurality of detent receiving features comprises a plurality of blind bores.

24. The variable ratio coupler of claim 22, wherein the plurality of detent receiving features comprises a plurality of through holes.

25. The variable ratio coupler of claim 22, wherein the at least one arcuate slot comprises a pair of arcuate slots.

26. The variable ratio coupler of claim 25, wherein each arcuate slot of the pair of arcuate slots oppose one another.

27. The variable ratio coupler of claim 22, wherein the cam comprises a plurality of zones, wherein a radius changes uniformly in each zone of the plurality of zones, and a rate of change of the radius is different among individual zones of the plurality of zones.

28. The variable ratio coupler of claim 27, wherein:
the plurality of zones comprises a first zone, a second zone, and a third zone;
in the first zone, the split ratio changes from a first split ratio to a second split ratio;
in the second zone, the split ratio changes from the second split ratio to a third split ratio; and
in the third zone, the split ratio changes from the third split ratio to the first split ratio.

29. The variable ratio coupler of claim 27, wherein:
the plurality of zones comprises a first zone and a second zone; and
the first zone has a range of rotation that is less than a range of rotation of the second zone.

30. A method of assembling a variable ratio coupler comprising:
positioning a compensation ring over a shaft such that a detent is positioned within a detent receiving feature corresponding to a first split ratio set point;
inputting an optical signal into an optical input of the variable ratio coupler;
measuring an optical power at a first optical output and a second optical output;
turning the shaft until a split ratio of optical power between the first optical output and the second optical output is at the first split ratio set point; and
securing the compensation ring to a housing of the variable ratio coupler.

31. The method of claim 30, wherein the compensation ring further comprises:
a ring body;
at least one arcuate slot within the ring body operable to receive at least one locking fastener;
a shaft opening within the ring body, wherein:
the at least one arcuate slot is at least partially surrounds the shaft opening;
the shaft opening defines an inner surface; and
the inner surface comprises a plurality of detent receiving features such that the detent receiving feature corresponding to the first split ratio set point is an individual one of the plurality of detent receiving features.

32. The method of claim 31, wherein securing the compensation ring to the housing comprises tightening the at least one locking fastener into the housing.

33. The method of claim 30, wherein the plurality of detent receiving features comprises a plurality of blind bores.

34. The method of claim 30, wherein the plurality of detent receiving features comprises a plurality of through holes.

35. The method of claim 30, wherein the at least one arcuate slot comprises a pair of arcuate slots.

36. The method of claim 35, wherein each arcuate slot of the pair of arcuate slots oppose one another.

37. A method of assembling a variable ratio coupler comprising:
positioning a compensation ring over a shaft such that a detent is positioned within a detent receiving feature corresponding to a first split ratio set point;
inputting an optical signal into an optical input of the variable ratio coupler;
measuring an optical power at a first optical output and a second optical output;
turning the shaft until a split ratio of optical power between the first optical output and the second optical output is at the first split ratio optical power set point; and
recording the position of the shaft;
sequentially turning the shaft until the split ratio of optical power is at a plurality of split ratio set points and recording the position of the shaft at each individual split ratio set point of the plurality of split ratio set points;
removing the compensation ring from the shaft;
fabricating a plurality of detent receiving features on the compensation ring according to the recorded positions of the shaft at the plurality of split ratio set points;
positioning the compensation ring over the shaft such that the detent is positioned within the detent receiving feature corresponding to the first split ratio set point;
inputting the optical signal into the optical input of the variable ratio coupler;
measuring the optical power at the first optical output and the second optical output;
turning the shaft until the split ratio of optical power between the first optical output and the second optical output is at the first split ratio optical power set point; and
securing the compensation ring to a housing of the variable ratio coupler.

38. The method of claim 37, wherein the compensation ring further comprises a ring body and at least one arcuate slot within the ring body operable to receive at least one locking fastener.

39. The method of claim 38, wherein securing the compensation ring to the housing comprises tightening the at least one locking fastener into the housing.

40. The method of claim 37, wherein the plurality of detent receiving features comprises a plurality of blind bores.

41. The method of claim 37, wherein the plurality of detent receiving features comprises a plurality of through holes.

42. The method of claim 37, wherein the at least one arcuate slot comprises a pair of arcuate slots.

43. The method of claim 42, wherein each arcuate slot of the pair of arcuate slots oppose one another.

44. A compensation ring for a variable ratio fiber optic coupler, the compensation ring comprising:
a ring body;
at least one arcuate slot within the ring body operable to receive at least one locking fastener;
a shaft opening within the ring body, wherein:
the at least one arcuate slot is at least partially surrounds the shaft opening;
the shaft opening defines an inner surface; and
the inner surface comprises a plurality of detent receiving features.

45. The compensation ring of claim 44, wherein the plurality of detent receiving features corresponds to a plurality of split ratio set points of the variable ratio fiber optic coupler.

46. The compensation ring of claim 44, wherein the plurality of detent receiving features comprises a plurality of blind bores.

47. The compensation ring of claim 44, wherein the plurality of detent receiving features comprises a plurality of through holes.

48. The compensation ring of claim 44, wherein the at least one arcuate slot comprises a pair of arcuate slots.

49. The compensation ring of claim 48, wherein each arcuate slot of the pair of arcuate slots oppose one another.
